(19) United States
(12) Patent Application Publication
(10) Pub. No.: US 2009/0199424 A1
(43) Pub. Date: Aug. 13, 2009

(54) Laundry Dryer

(76) Inventors: Sang Hun Bae, Gyeongsangnam-do (KR); Chul Jin Choi, Gyeongsangnam-do (KR); Dong Hyun Kim, Gyeongsangnam-do (KR); Young Bok Son, Gyeongsangnam-do (KR)

Correspondence Address: MCKENNA LONG & ALDRIDGE LLP, 1900 K STREET, NW, WASHINGTON, DC, 20006, US

(21) Appl. No.: 12/309,486

(22) PCT Filed: Jun. 15, 2007
(86) PCT No.: PCT/KR2007/002897

§ 371 Date: Jan. 21, 2009

(30) Foreign Application Priority Data
Sep. 25, 2006 (KR) 10-2006-0092834

(51) Int. Cl. F26B 19/00; D06F 58/04

(52) U.S. Cl. 34/60; 34/132

(57) ABSTRACT

The present invention relates to a dryer. The dryer includes a drum (20) for holding a drying object, a hot air heater (90) for heating air to supply hot air to the drum, and a fine water particle generating device (410) for generating fine water particles to supply the fine water particles to the drum (20), thereby permitting effective removal of creases from clothes.

### TECHNICAL FIELD

The present invention relates to laundry dryer. More specifically, the present invention relates to a laundry dryer which can remove or prevent formation of creases or folds on clothes.

### BACKGROUND ART

Generally, the dryer is a home appliance for drying washed laundry, i.e., mostly clothes, with hot air. In general, the dryer is provided with a drum for holding a drying object, a driving source for driving the drum, heating means for heating air to be introduced to the drum, and a blower unit for drawing in or discharging air from the drum.

Depending on methods for heating the air, i.e., the heating means, there may be electric type dryers, and gas type dryers. The electric type dryer heat the air with heat from electric resistance, and the gas type dryer heats the air with heat of burning gas. If the dryers are sorted in another fashion, there may be condensing type dryers, and exhaust type dryers. In the condensing type dryer, air which becomes humid as a result of heat exchange with the drying object at the drum is not discharged to an outside of the dryer, but circulated in the dryer, and heat exchanged at a separate condenser to form condensed water which is discharged to an outside of the dryer. In the exhaust type dryer, the air which becomes humid as a result of heat exchange with the drying object at the drum is discharged to an outside of the dryer, directly. If the dryers are sorted in another fashion, there may be top loading type dryers and front loading type dryers depending on methods for introducing the clothes into the dryer. In the top loading type dryers, the clothes is introduced into the dryer from a top side, and in the front loading type dryers, the clothes is introduced into the dryer from a front side.

### DISCLOSURE OF INVENTION

### Technical Problem

The related art dryer has the following problems.

In general, laundry washed and having water extracted therefrom is introduced to the dryer for drying. However, in view of water washing principle, it is inevitable that the laundry washed with water has creases, and the creases are not eliminated in a course of drying, perfectly. Consequently, in order to eliminate the creases from the drying object, such as the laundry, dried at the related art dryer, separate pressing has been required.

Moreover, besides the washed laundry, in cases clothes are stored, and used conventionally, creases, rumples, folds, and the like (called as creases collectively) are formed. Accordingly, development of a device for easy removal of the creases caused by such conventional use, and storage of clothes has been required.

### Technical Solution

To solve the problems, an object of the present invention is to provide a dryer which can prevent and/or remove creases from clothes, or the like.

Another object of the present invention is to provide a dryer which has a fine water particle generating device of a type different from a steam generator.

To achieve these objects and other advantages and in accordance with the purpose of the invention, as embodied and broadly described herein, a dryer includes a drum for holding a drying object, a hot air heater for heating air to supply hot air to the drum, and a fine water particle generating device for generating fine water particles to supply the fine water particles to the drum.

The fine water particle generating device includes an ultrasonic oscillator.

The ultrasonic oscillator is placed in a body having a space for holding water, and the dryer further includes a water supply source for holding water to be supplied to the body.

Preferably, the dryer further includes a water supply source for holding water, and the ultrasonic oscillator is provided to the water supply source.

The dryer further includes a nozzle provided to at least one of a front, and a rear of the drum, and on a hot air supply duct for spraying the fine water particles to the drum.

The nozzle is provided adjacent to an opening portion in the rear of the drum.

### ADVANTAGEOUS EFFECTS

The dryer of the present invention has the following advantages.

First, formation of creases or rumples on dried clothes can be prevented or removed. Moreover, clothes can be sterilized, or deodored.

Second, creases or rumples can be removed from clothes of a dried state without separate pressing, effectively.

Third, the application of the fine water particle generating device which generates atomized water particles like fog instead of the steam generator permits to provide a simple device and save a production cost.

### BRIEF DESCRIPTION OF THE DRAWINGS

The accompanying drawings, which are included to provide further understanding of the disclosure, illustrate embodiments of the disclosure and together with the description serve to explain the principle of the disclosure.

In the drawings:

FIG. 1 illustrates an exploded perspective view of a dryer in accordance with a preferred embodiment of the present invention;

FIG. 2 illustrates a longitudinal section of the dryer in FIG. 1;

FIG. 3 illustrates a section of a steam generator in FIG. 1;

FIG. 4 illustrates a diagram of a dryer in accordance with another preferred embodiment of the present invention, schematically;

FIG. 5 illustrates a diagram of a dryer in accordance with another preferred embodiment of the present invention, schematically;

FIG. 6 illustrates a variation of FIG. 5, schematically; and

FIGS. 7 and 8 each illustrates a diagram of a dryer in accordance with another preferred embodiment of the present invention, schematically.

### BEST MODE FOR CARRYING OUT THE INVENTION

Reference will now be made in detail to the specific embodiments of the present invention, examples of which are illustrated in the accompanying drawings.

In order to describe a dryer of the present invention, a top loading type, electric type, and the condensing type dryer will be taken as an embodiment for the sake of convenience. However, the present invention is not limited to this, but the present invention is applicable to front loading type, gas type, and condensing type dryers, too.

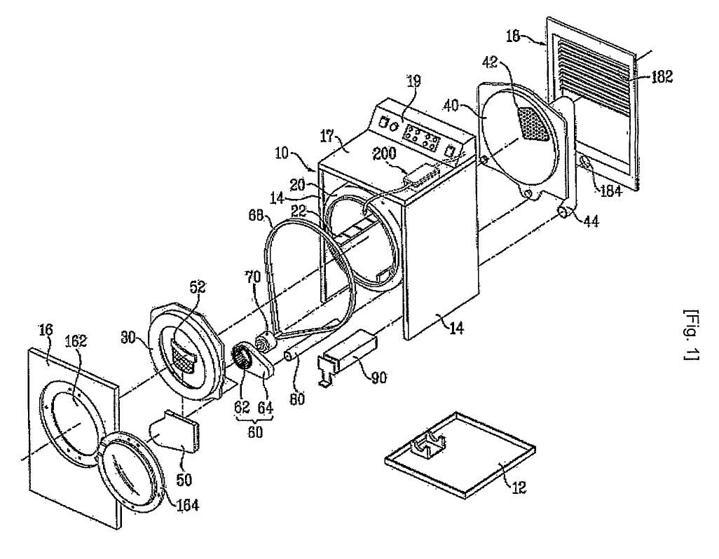

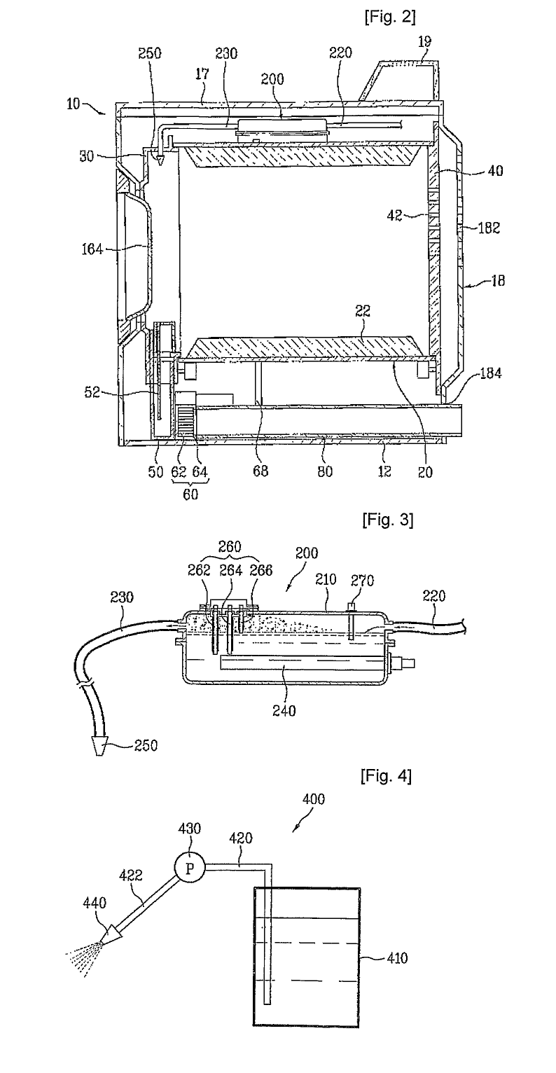

A dryer in accordance with a preferred embodiment of the present invention will be described with reference to FIGS. 1 and 2.

Inside of a cabinet 10 which forms an exterior of the dryer, there are a rotatable drum 20, a motor 70 and a belt 68 for driving the drum 20. Mounted at a predetermined location of the cabinet 10, there are a heater 90 (will be called as hot air heater) for heating air to produce high temperature air (will be called as hot air), and a hot air supply duct 44 for supplying the hot air from the hot air heater 90 to the drum 20.

And, an exhaust duct 80 for discharging humid air heat exchanged with the laundry at the drum 20 and a blower unit 60 for drawing in the humid air are also mounted. In the meantime, mounted at a predetermined location of the cabinet 10, there is a steam generator 200 for generating hot steam.

For convenience sake, in the embodiment, though the present invention is shown and described based on an indirect drive type in which the drum 20 is rotated by using the motor 70 and the belt 68, the present invention is not limited this, but the present invention is also applicable to a direct drive type in which the drum 20 is rotated directly by a motor directly connected to a rear of the drum 20.

Respective elements of the dryer will be described in detail.

The cabinet 10 which forms an exterior of the dryer includes a base 12 which forms a bottom of the dryer, one pair of side covers 14 mounted to the base 12 vertically, a front cover 16 and a rear cover 18 mounted to a front and a rear of the side covers 14 respectively, and a top cover 17 located on top of the side covers 4.

A control panel 19 with various operation switches is conventionally located on the top cover 17 or the front cover 16. The rear cover 18 has an inlet 182 for introduction of external air, and an exhaust hole 184 which is a final passage for discharging the air from the drum 20 to an outside of the dryer.

An inside space of the drum 20 serves as a drying chamber for drying the clothes, and, it is preferable that lifts 22 are provided in the drum 20 for lifting and dropping clothes, to turn the clothes upside down for enhancing drying efficiency.

In the meantime, mounted between the drum 20 and the cabinet 10, i.e., between the drum 20 and the front cover 16, there is a front supporter 30, and mounted between the drum 20 and the rear cover 18, there is a rear supporter 40. Rotatably mounted between the front supporter 30 and the rear supporter 40, there is the drum 20, and mounted between the front supporter 30 and the rear supporter 40 and the drum 20, there are sealing members (not shown) for preventing leakage.

That is, the front supporter 30 and the rear supporter 40 cover the front and rear of the drum 20 to form the drying chamber, and support the front and rear of the drum 20, respectively.

The front supporter 30 has an opening to make the drum 20 to be in communication with an outside of the dryer, and the opening has a door 164 for selective opening/closing. The front supporter 30 also has a lint duct 50 connected thereto, which is a passage of the air from the drum 20 to an outside of the dryer, with a lint filter 52 mounted thereto. The blower unit 60 has one side connected to the lint duct 50, and the other side connected to the exhaust duct 80 which is connected to the exhaust hole 184 in the rear cover 18.

Accordingly, if the blower unit 60 is operated, the air is discharged to an outside of the dryer from the drum 20 through the lint duct 50, the exhaust duct 80, and the exhaust hole 184. In this instance, foreign matters, such as lint, are filtered at the lint filter 52.

In general, the blower unit 60 includes a blower 62 and a blower housing 64, and, in general, the blower 64 is driven by the motor 70 which also drives the drum 20. That is, in general, when the motor 70 is operated, both the blower unit 60 and the drum 20 are driven at the same time.

The rear supporter 40 has an opening portion 42 having, in general, a plurality of pass through holes, with the hot air supply duct 44 connected thereto. The hot air supply duct 44 is in communication with the drum 20 for serving as a passage for supplying the hot air to the drum 20. Accordingly, the hot air heater 90 is mounted to a predetermined location of the hot air supply duct 44.

In the meantime, mounted to a predetermined location of the cabinet 10, there is the steam generator 200 for generating steam and supplying the steam to the drum 20. The steam generator 200 will be described in detail with reference to FIG. 3.

Mounted in the steam generator 200, there are a water tank 210 for holding water, a heater 240 mounted to an inside of the water tank 210, a water level sensor 260 for measuring a water level of the steam generator 200, and a temperature sensor 270 for measuring a temperature of the steam generator 200.

In general, the water level sensor 260 includes a common electrode 262, a low water level electrode 264, and a high water level electrode 266 for sensing a high water level or a low water level depending on electric conduction between the common electrode 262 and the high water level electrode 264 or the common electrode 262 and the low water level electrode 266.

The steam generator 200 has one side connected to a water supply hose 220 for supplying water, and the other side connected to a steam hose 230 for discharging steam, and it is preferable that a predetermined shape of nozzle 250 is provided to a fore end of the steam hose 230.

In general, one end of the water supply hose 220 is connected to an external water supply source, such as tap, and the fore end or the nozzle 25 of the steam hose 230, i.e., a steam outlet is located at a predetermined location of the drum 20, for spraying the steam to an inside of the drum 20.

In the meantime, though the embodiment shows and describes a steam generator 200 (will be called as a tank heating type for convenience sake) in which an amount of water held in the water tank 210 of a predetermined size is heated with the heater 240 to generate the steam, the present invention is not limited to this.

That is, the present invention can use any steam generator as far as the device can generate the steam. For an example, a system may also be used, in which a heater is mounted around a water supply hose through which water passes for heating the water without holding the water within a space (for convenience sake, will be called as a tubular heating system).

A dryer in accordance with another preferred embodiment of the present invention will be described with reference to FIGS. 4 to 6.

As described before, according to the inventor s study, it is known that uniform spread and supply of appropriate moisture to the clothes, appropriate heating of the clothes for restoring the creases, and application of appropriate force (load) to the clothes, is required for more effective removal of the creases from the clothes.

In the foregoing embodiment, the hot steam is supplied to the clothes from the steam generator for appropriate supply and heating of the clothes. However, different from the foregoing embodiment, a fine water particle generating device 400 is used in the embodiment instead of the steam generator for atomizing the moisture. In general, the hot air heater is operated when the dryer is in operation, such that an inside of the drum is in an environment of a temperature higher than 80 C.

Therefore, because the inside of the drum itself can be made to be at a high temperature, in a point of view that the steam can be generated in the inside of the drum only if water is made to be fine particles without heating the water, the embodiment uses the fine water particle generating device 400. If the fine water particle generating device 400 is used instead of the steam generator, the safety devices required for using the steam generator can be dispensed with, enabling to simplify the dryer, and reduce a production cost.

Moreover, since heating of the water is not required if the fine water particle generating device 400 is used, formation of scale can be prevented, that is liable to take place when the steam generator is used, particularly, when the hardness of the water is high.

The dryer in accordance with another preferred embodiment of the present invention will be described with reference to FIG. 4.

The fine water particle generating device 400 includes a pump 430 for applying a pressure to the water to be supplied from a water supply source 410, and a nozzle 440 connected to the pump 430. That is, the embodiment suggests utilizing a kind of sprayer principle for making the water into fine water particles.

In this instance, the fine water particle is a water particle of, not water accelerated through a conventional nozzle, but water atomized like fog through the nozzle 440 that adapts the sprayer principle.

The principle utilizes the Bernoulli principle, which is known, of which detailed description will be omitted. Unexplained reference numerals 420, and 422 denote a water supply hose and a fine water particle hose, respectively.

As described before, by applying a pressure to the water, and spraying the pressurized water through a nozzle 440 having a section of which area is changing, the water can be turned into the fine particles. An output of the pump 430 and a diameter of the nozzle 440 can be determined by appropriate calculation and test, taking degrees of atomization of the water into account.

In the meantime, it is preferable that the water supply source 410 a separate water tank instead of a water tap, and more preferably, a detachable water tank.

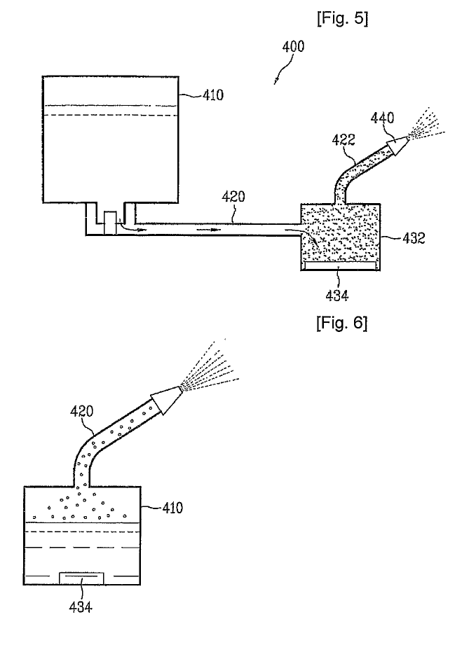

The dryer in accordance with another preferred embodiment of the present invention will be described with reference to FIG. 5.

The embodiment suggests atomizing the moisture with an ultrasonic oscillator 434. Since a principle for atomizing the moisture with the ultrasonic oscillator 434 is widely applied to humidifiers and the like, detailed description of which will be omitted.

A body 434 having the ultrasonic oscillator 434 provided thereto has one side connected to the water supply source 410 through the water supply hose 420, and the other side connected to the fine water particle hose 422. It is preferable that the fine water particle hose 422 has a fore end provided with a nozzle 440 of an appropriate shape. It is also preferable that the water supply source 410 is a separate water tank, and more preferably, the water supply source 410 is a detachable water tank.

The dryer in accordance with another preferred embodiment of the present invention will be described with reference to FIG. 6.

Alike the foregoing embodiment, the embodiment also suggests atomization of the moisture with the ultrasonic oscillator 434. However, the embodiment suggests mounting of the ultrasonic oscillator 434 to the water supply source 410 directly, without the separate body for mounting the ultrasonic oscillator thereto.

In the meantime, the fine water particle generating device 400 can be mounted to any of a top, an underside, and sides of the drum 400. Particularly, since a size can be reduced, a case is more favorable, in which the ultrasonic oscillator 434 is mounted to the water supply source 410, directly.

The operation of the embodiments of the present invention having the fine water particle generating device applied thereto will be described, with reference to FIGS. 4 to 6.

The water supply source 410 supplies water to the fine water particle generating device 400. Particularly, in a case the water supply source 410 is the detachable water tank, the user separates the water tank from the dryer, fills water in the water tank, and mounts the water tank to the dryer.

In this state, if the dryer is put into operation, the atomized fine water particles are supplied to the drum. For an example, in a condition the fine water particle generating device 400 is in operation, the water is atomized like fog, and the atomized fine water particles are supplied to the drum, thereby supplying the fine water particles to the clothes spread all over the clothes, appropriately.

In this instance, if the hot air heater (see FIG. 1) is put into operation at an appropriate time point, to make the drum to be in a high temperature environment, the high temperature environment helps removal of the creases from the drying object. The time point when the hot air heater is put into operation is not limited, but may be determined appropriately through tests or the like.

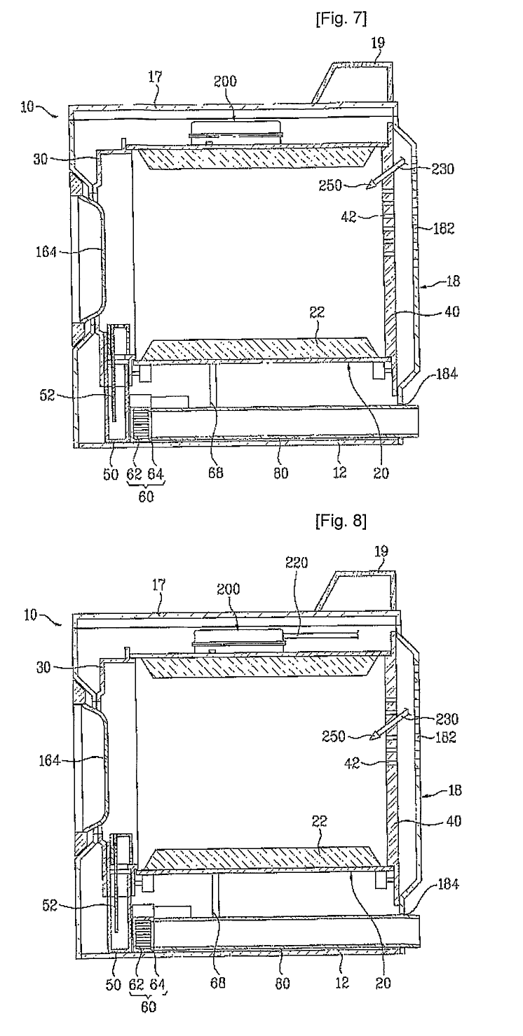

A location of mounting of the fine water particle generating device of the present invention will be described with reference to FIGS. 7 and 8.

The fine water particle generating device 400, a fore end thereof, may be mounted to a rear of the drum 20. In this instance, it is preferable that the fine water particle generating device 400 is mounted to the rear supporter 40, adjacent to the opening portion 42 which is an introduction opening of the hot air to the drum, or at the opening portion 42. The fine water particle generating device 400 may be mounted to a predetermined location of the hot air supply duct 44, for an example, adjacent to the opening portion 42.

In the meantime, the mounting location of the fore end of the fine water particle generating device 400 is not limited to one place, but the fore end may be branched and the branches may also be mounted, appropriately.

Moreover, not only the fore end of the fine water particle generating device 400, but also an entire unit of the fine water particle generating device 400 can also be mounted to above location, because fabrication of a comparatively small sized fine water particle generating device 400 is also possible in the present invention.

According to a test of the inventor, even though there are differences depending on kinds of clothes, for an example, kinds of fabrics, and degrees of water absorption, the dryer of the present invention has crease removal and prevention effects. As one example of the drying object, the laundry having washed at a washing machine may fall on the drying object, but the drying object is not limited to this.

For an example, if creases on clothes put on or about one day, i.e., clothes already in a dried state with small creases, can be removed at the dryer of the present invention, such a case can be especially useful. That is, as a kind of crease removal appliance, the dryer of the present invention may be used.

### INDUSTRIAL APPLICABILITY

The dryer of the present invention has the following advantages.

First, formation of creases or rumples on dried clothes can be prevented or removed. Moreover, clothes can be sterilized, or deodored.

Second, creases or rumples can be removed from clothes of a dried state without separate pressing, effectively.

Third, the application of the fine water particle generating device which generates atomized water particles like fig instead of the steam generator permits to provide a simple device and save a production cost.

1. A dryer comprising:
a drum for laundry to be placed in;
a hot air heater to heat air to supply hot air to the drum; and
a fine water particle generating device to generate fine water particles to supply the fine water particles to the drum, wherein the fine water particle generating device comprises an ultrasonic oscillator.

2. (canceled)

3. The dryer as claimed in claim 1, wherein the ultrasonic oscillator is placed in a body having a space for holding water, and the dryer further comprising a water supply source for holding water to be supplied to the body.

4. The dryer as claimed in claim 1, further comprising a water supply source for holding water, and the ultrasonic oscillator is provided to the water supply source.

5. The dryer as claimed in claim 1, further comprising a nozzle to spray the fine water particles, wherein the nozzle placed at least in one place among in front or rear of the drum and in.

6. The dryer as claimed in claim 5, wherein the nozzle is provided adjacent to an opening through which the hot air flows into the drum.

7. A dryer comprising:
a drum for laundry to be placed in;
a hot air healer to heat air to supply hot air to the drum; and
a nozzle through which pressurized water is turned into fine water particles and supplied to the drum.

8. The dryer as claimed in claim 7, further comprising a water tank to hold water and a pump to pressurize the water.

9. The dryer as claimed in claim 8, wherein the water tank is detachable to the dryer.

10. The dryer as claimed in claim 7, wherein the nozzle is provided to a rear supporter which supports a rear part of the drum.

11. The dryer as claimed in claim 10, wherein the nozzle is provided adjacent to an opening through which the hot air flows into the drum.
